(19) United States
(12) Patent Application Publication
(10) Pub. No.: US 2019/0265787 A1
(43) Pub. Date: Aug. 29, 2019

(54) REAL WORLD INTERACTION UTILIZING GAZE

(71) Applicant: Tobii AB, Danderyd (SE)

(72) Inventors: Anders Vennström, Danderyd (SE); Mårten Skogö, Danderyd (SE)

(73) Assignee: Tobii AB, Danderyd (SE)

(21) Appl. No.: 16/285,720

(22) Filed: Feb. 26, 2019

(30) Foreign Application Priority Data
Feb. 26, 2018 (SE) 1850219-5

(51) Int. Cl. G06F 3/01; H04N 5/232; G06F 1/16

(52) U.S. Cl. CPC G06F 3/013; H04N 5/23299; G06F 1/163; H04N 5/23296; H04N 5/23212

(57) ABSTRACT

Methods and systems are disclosed for assisting a user using a system including an eye tracker and a device, the device being configured to be worn on a limb of the user or held in the hands of the user. The methods and uses of systems disclosed include the steps of (1) tracking the user's gaze direction in a real world environment and determining a real world object, subject, or item the user is currently focusing on based on the user's gaze direction; and (2) providing information and/or an option to adjust at least one parameter, preferably via the device, based on the identified real world object, subject or item.

### CROSS-REFERENCE TO RELATED APPLICATIONS

This application claims the benefit of Swedish Patent Application No. 1850219-5, filed on Feb. 26, 2018; the contents of which are hereby incorporated by reference, for all purposes, as if fully set forth herein.

### BACKGROUND OF THE INVENTION

The present invention generally relates to systems and methods for interacting with a natural or real world environment, and in particular, to systems and methods for interacting with an environment utilizing a user's gaze and gaze direction as part of that interaction

An eye tracker or a gaze tracker determines a user's gaze direction and is available in many form factors, including remote and wearable systems. Remote systems typically comprise an image sensor and one more infrared light sources located remote from a user, for example in a laptop, phone, gaming device, tablet or the like. Wearable systems typically comprise at least one image sensor and at least one infrared light source in a wearable device such as a Virtual Reality headset, Augmented Reality headset or other wearable device.

Typically gaze tracking devices are used to interact with a virtual environment such as an operating system, video game, virtual reality environment or augmented reality environment. Typical devices for such a purpose are Virtual Reality (VR) headsets comprising an eye tracker and a camera or head up displays comprising an eye tracker combined with a camera in cars. In both cases the eye tracker is arranged at a fixed distance to the eyes of the user.

A disadvantage of the above examples is that while the VR headset is socially accepted in game rooms and other virtual reality application it is difficult and cumbersome to use a VR headset when controlling parameters in a smart home in home automation or when controlling specific applications of a tablet or smartphone in a natural environment. The same can be said for the head up display of a car;—it is not practical yet to use a head up display device for controlling parameters in a smart home or in home automation or in the natural environment. As an example it is highly unlikely that a user will put on a VR headset every time she or he wants to change a TV channel on the smart TV or when the played audio on the loudspeaker is to be changed.

Another disadvantage of the above examples is that a user needs to carry an extra device, in the form of a VR headset or other device.

### SUMMARY OF THE INVENTION

Thus, an object of the present invention is to provide systems and methods for interacting with a real world environment utilizing gaze information of a user obtained from a handheld device or a device that is worn on a limb of a user. This and other objects of the present invention will be made apparent from the specification and claims together with appended drawings.

A further object of the present invention is to provide assistance to a user whereby the user does not need to look at a screen of the device but can entirely focus her/his gaze on the real world environment.

The inventors of the present invention have discovered that it is possible to track a user's gaze direction in the real world environment without the user looking directly at a device/eye tracker or a screen of the device and use that gaze direction in the real world environment to interact via the device such as a mobile phone, tablet, gaming device or smart watch.

According to a first aspect of the present invention, there is provided a method for assisting a user using a system comprising an eye tracker and a device, the device being configured to be worn on a limb of the user or held in the hands of the user, the method comprising the steps of: (1) tracking the user's gaze direction in the real world environment; and (2) providing information and/or an option to adjust at least one parameter of an apparatus, for example via the device, based on the user's gaze direction.

In many cases it might be enough for the eye tracker to determine head position of the user to establish a general assumption of what the user is seeing. This may in particular be of importance if the eye tracker or eye tracking is not capable of establishing gaze direction and has to proceed with the general head position.

As a backup function the method and system according to the invention may thus comprise the possibility of the eye tracker and the processing unit, respectively, to establish the head positioning of the user. The device may then assume the user's gaze direction or general direction at what he is looking at by correlating for example historic or empiric data.

In an embodiment the method may further comprise the steps of determining a real world object, subject or item the user is currently focusing on based on the user's gaze direction and to provide information and/or an option to adjust at least one parameter of an apparatus, for example via the device, based on the identified real world object, subject or item.

In some cases it might be enough to identify and determine the gaze direction to establish and provide the option to adjust the at least one parameter of an apparatus. This may for instance be the case when the device is in the photo application as further explained below.

With the above described method it is possible to use an everyday object such as a mobile phone, a portable gaming device, a tablet or a smart watch to provide information on an object, subject or item the user is currently focusing his gaze on or to provide the option to adjust at least one parameter of an apparatus based on the identified object, subject or item on which the user is currently focusing his gaze on.

The information can be provided via an audio output of the device and the at least one parameter can be adjusted automatically.

According to a second aspect of the present invention there is provided a system comprising (1) a device comprising a processing unit, a memory and a camera arranged on the device; and (2) an eye tracker, the eye tracker capable of determining a user's gaze direction in the real world environment, the processing unit, the memory, the camera and the eye tracker being connected to one another; wherein the device is configured to be worn on a limb of the user or held in the hands of the user and wherein the eye tracker is configured to track the user's gaze direction in the real world environment and wherein the processing unit is configured to provide information and/or an option to adjust at least one parameter of an apparatus via the device, based on the user's gaze direction.

In another embodiment the processing unit may further be configured to determine a real world object, subject or item the user is currently focusing on based on the user's gaze direction and to provide information and/or an option to adjust at least one parameter of an apparatus, for example via the device, based on the identified real world object, subject or item.

The camera on the device may be any type of regular camera, such as a time of flight camera, a wide angle camera, a depth camera or any other type of camera.

Alternatively the camera may be any type of environmental mapping sensor that is capable to read and record the environment such as a 3D camera with active lightning or radar, lidar, and ultrasound devices.

Using the above system it is possible for the user to avoid looking at the device in order to get requested information or to adjust at least one parameter of an apparatus based on the real world object, subject or item identified via the user's gaze direction.

The above described method and system, respectively, will allow a user to interact with a device without directly looking at it. The device can be held at an angle to the user's eyes it does not need to be held directly in front of the eyes. This may allow a user to discreetly take a picture or discreetly obtain information, as further described below.

In an embodiment the at least one parameter may be an operating parameter of a home automated appliance or an internet of thing appliance.

In this case the identified real world object, subject or item is thus an object or item such as the home automated appliance or the internet of thing appliance.

In another embodiment the method may further comprise the steps of (1) inputting input information into the device; and (2) providing information or the option to adjust the at least one parameter of an apparatus depending on the input information.

The input information may help the device to understand what kind of assistance that is required.

In some of the above described situations the input information is the identified real world object, subject or item and the device will instinctively or based on empiric data or historic data know what the user intends to do.

In other situations the input information may be to translate the real world object or item, which translation can then be provided visually on a display of the device or via an audio signal for example through headphones connected to the device.

In another embodiment the input information may be to take a picture and the at least one parameter of an apparatus may be to focus a camera of the device on the identified real world object, subject, or item (thus, in some embodiments, the apparatus for which a parameter is modified may be the real world object, subject, or item; in other embodiments, the device worn or held by the user may be the apparatus for which a parameter is modified).

Adjusting the focus of the camera based on the user's gaze direction and the identified real-world object, subject or item could even be used as a standard function as soon as the camera application on the device is opened.

The at least one parameter may alternatively be to manipulate the picture depending the user's gaze direction. The manipulation may be to crop rotate or post the picture online.

In some aspects of the present invention, the device may comprise a display for displaying information based on the user's gaze direction in the real world environment and the identified real world object, subject or item.

In an embodiment the device may be configured to be worn on a limb, such as for example the wrist, such as a smart watch.

In a further embodiment the device may be a hand held device such as a mobile phone, a tablet or a gaming device.

In another embodiment the eye tracker may comprise a light source and a wide angle camera.

In some aspects also the camera arranged on the device may be a wide angle camera.

Such wide angle cameras may further extend the user's ability to hold the device in various angles in relation to the eyes, thus the device does not need to be held in front of the eyes and the user can focus her/his gaze on the real world environment without looking at the device.

In still a further embodiment the device may comprise an interface for inputting input information into the device and for communication with the user.

The interface may be a touch screen or a microphone or the like.

The processing unit and the memory may be configured to adjust the at least one parameter depending on the input information and/or the user's gaze direction.

In some embodiments the camera arranged on the device may be positioned on the frame or any other periphery of the device.

In general the above described invention allows a user to look past the device or at least past a display of the device and still interact with the device via gaze tracking and the device.

In some embodiments the eye tracker may be integrated in the device or it may be separate. In other embodiments the eye tracker may use the camera on the device and its own camera to determine eye.

Embodiments of the invention further relate to a non-transitory machine readable medium having instructions stored therein for performing a method to assist a user as described above.

### BRIEF DESCRIPTION OF THE DRAWINGS

The present invention will now be described, for exemplary purposes, in more detail by way of an embodiment and with reference to the enclosed drawings, in which:

FIG. 1 schematically illustrates a system according to the invention;

FIG. 2 schematically illustrates an example of the embodiment of the present invention where a device having a camera and an eye tracker is used to sharpen the focus of the camera onto an object fixated by the user's gaze direction;

FIG. 3 schematically illustrates another example of the embodiment of the present invention where the device having the camera and the eye tracker is used to sharpen the focus of the camera onto the object fixated by the user's gaze direction and zoom on to the object take a picture and/or even crop the picture afterwards all based on the user's gaze direction;

FIG. 4 schematically illustrates still another example of the embodiment of the present invention where the device having the camera and the eye tracker is used to control a home automated appliance, in this case a lamp, via the device and the eye tracker, respectively; and

FIG. 5 schematically illustrates a method according to the invention.

### DETAILED DESCRIPTION OF THE INVENTION

FIGS. 2-4 illustrate three examples how the system 1 and the method according to the present invention may be employed and used. The examples are not intended to be limiting. Instead they are intended to rather exemplary illustrate the invention so that it can be easily understood.

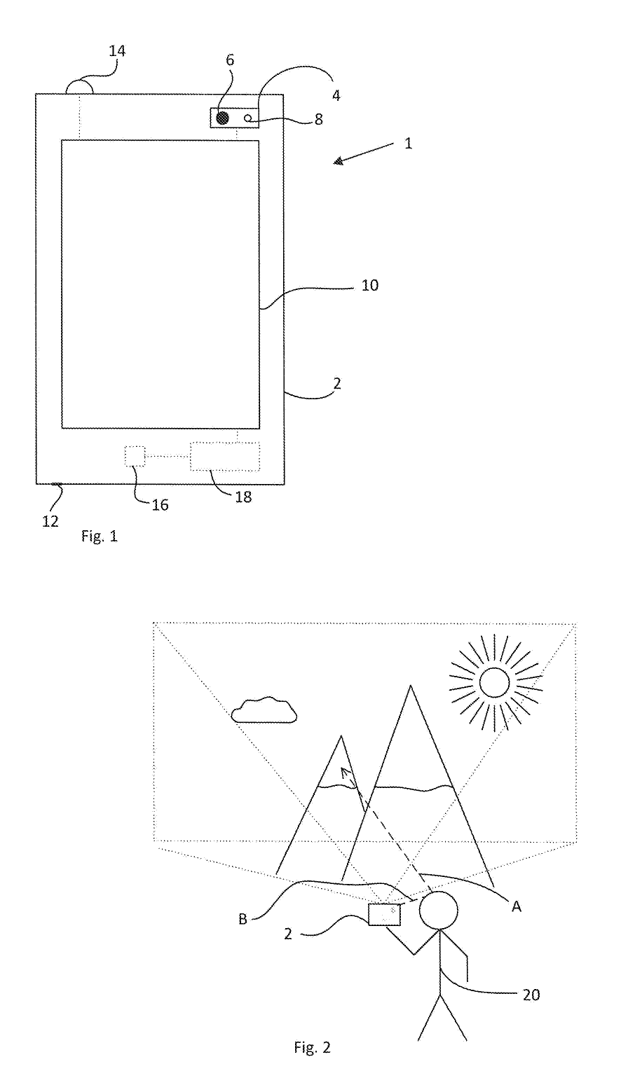

FIG. 1 schematically illustrates the system 1 according to the invention comprising a device 2 and an eye tracker 4. In the illustrated system 1 the eye tracker 4 is integrated in the device 2, it may however also be arranged separately from the device 2 and communicate with the device 2. The eye tracker 4 comprises an eye tracking camera 6, such as any type of camera available, and a light source 8. The camera 6 may be a time of flight camera some other type of depth camera, an active near-infrared (NIR) camera, a regular red/green/blue (RGB) camera or any type of camera.

The device 2 may further comprise an interface 10, here illustrated in the form of a screen, and a loud speaker 12 or audio output. The device 2 further comprises a camera 14, which can be again any type or sort of camera, such as a wide angle camera, a 360° camera, a time of flight camera, some other type of camera or an active NIR camera. In FIG. 1 the camera 14 is positioned on the edge of the device 2, it is however possible to position the camera 14 anywhere on the periphery of the device 2.

FIG. 1 further illustrates a memory 16 and a processing unit 18, which are shown in dotted lines since they are built into the device 2. The processing unit 18, the memory 16, the camera 14, the audio output 12, the interface 10 and the eye tracker 4 are all connected with one another for powering and/or communication purposes. This is indicated with the dotted lines between the different features.

The interface 10 may be a display or a touch display.

The device 2 may be a gaming device, a smart watch, a tablet or a phone. In FIG. 1 the device 2 is illustrated as a smart phone or a tablet.

### EXAMPLE 1

FIG. 2 illustrates a user 20 taking a picture of a panorama, in this case a mountain panorama with a big and a small mountain. The user 20 holds the device 2 a bit to the side of his/her face and lower than the face and is looking at the mountains. The dashed arrow A from the user's 20 head and eyes, respectively, to the smaller one of the two mountains indicates at what the user 20 is looking at. Thus the dashed arrow A indicates the gaze direction of the user 20 and thus the area which is seen sharp by the user 20. The dashed line B from the device 2 to the user 20 indicates the interaction between the eye tracker and the user's eye. By tracking the user's eyes the device 2 can establish at what real world object, subject or item the user 20 is currently looking at. In this example 1 the user 20 is looking at the smaller one of the two mountains.

The device 2 may have been put into photography mode previously or the user 20 may have given an input information to the device that she/he wants to take a picture. The device 2 and the eye tracker, respectively, is tracking the user's gaze direction and automatically focuses the camera (camera 14 of FIG. 1) onto the smaller mountain and takes a pictures without the user 20 looking at the device 2 and without the user 20 holding the device in front of his or her face/eyes. The dotted lines indicates the picture size that is captured. As can be seen from FIG. 2, the size of the picture is quite large and the lens of the camera (camera 14) was not zoomed in onto the smaller mountain.

The example 1 is quite simple and straight forward and easy to understand. One can imagine that this application using the tracking of the user's gaze is very interesting when the object, subject or item is a moving element, such as a sportsperson running or cycling. The user 20 can basically just track the sportsperson with his/her eyes and the device 2 automatically sharpens and setts the focus of the camera 14 onto the sportsperson without the user 20 looking at the device 2. A voice command may then be given from the user 20 to the device 2 to take a picture or a button on the device may be pushed to take a picture.

Example 1 may or may not require to input information into the device prior to starting the eye tracking process in the real world environment. The device 2 may automatically recognize what the user 20 intends to do or it may know it through an input information, such as “open the camera application”.

### EXAMPLE 2

Example 2 is a similar application as example 1 but with another parameter that is adjusted. The device 2 is also in the camera application either by automatically tracking the user's 20 intentions or by previously received input information that the user 20 wants to take a picture.

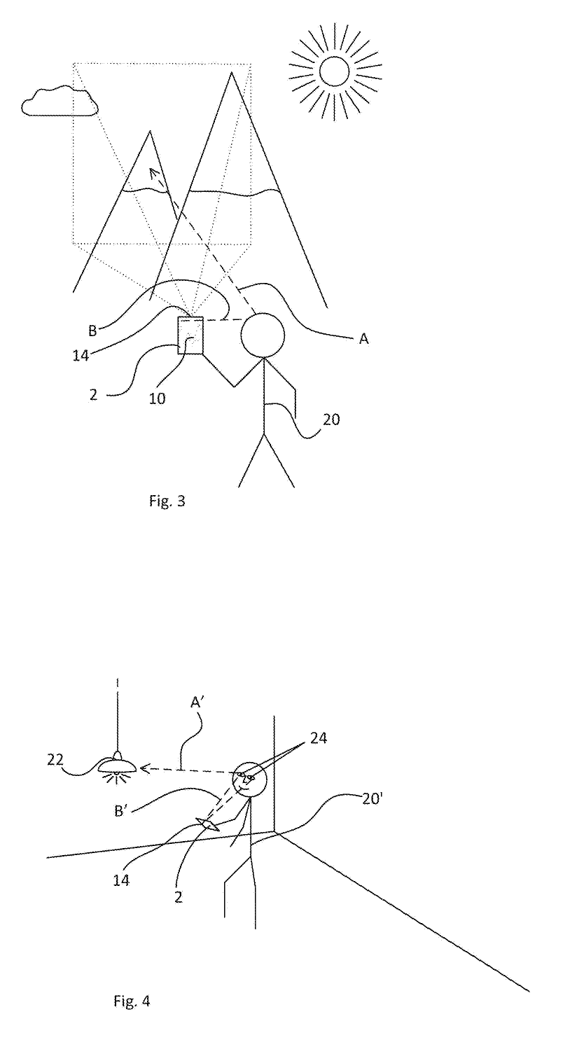

Tracking the user's gaze direction (dashed line B), which is again indicated by the arrow A, the user 20 is looking at the smaller one of the two mountains. Since the eye tracker is tracking B the user's gaze direction, the device 2 can correlate where the user 20 is looking. The device 2 and the processing unit 18, respectively, can then automatically zoom the camera lens onto the smaller one of the two mountains, i.e. adjusting at least one parameter, without the user looking at the device. Alternatively or additionally, the camera application on the device can also crop the picture, i.e. adjusting at least one parameter, depending on the user's 20 gaze direction A and the identified real world object, subject or item, which in this case is the smaller one of the two mountains illustrated in FIG. 3.

As indicated the device 2 and the processing unit 18, respectively may adjust two parameters, in this case zooming onto the identified real world object and cropping the picture after it has been taken. The user 20 may input information into the device that she or he also wants to crop the picture prior to taking the picture. This can be done via the screen 10, via voice control or by pushing a button on the device 2, etc.

The two parameters “zooming in” and “cropping” may however also be adjusted automatically.

The dotted frame in FIG. 3 indicates the “size” of the picture and the amount of zooming. On the device 2's screen 10 the picture is also indicated. Although the size of the picture on the device 2 and the frame indicated by the dotted lines correspond to one another, this does not necessarily need to be the case. The picture on the screen 10 of the device 2 could indicate the cropped picture and it does not need to be the same as the zoomed in frame of the camera 14, which is indicated by the dotted frame and the dotted lines.

In FIGS. 2 and 3 the user 20 is looking at the mountains and the figures are illustrated from behind the user 20, so that the eyes of the user 20 are not visible. The device 2 is held in front of the user's body.

### EXAMPLE 3

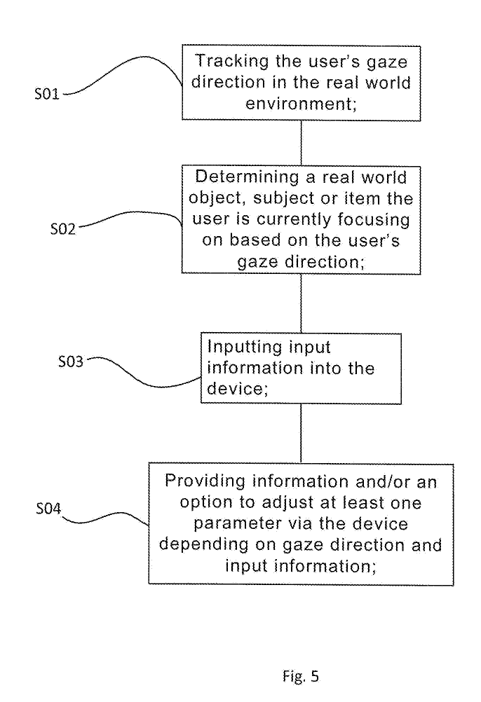

In FIG. 4 another application of the system and the method according to the present invention is illustrated.

The user 20′ is in an apartment or in his/her home and intends to dim or switch on/off a smart lamp 22. The smart lamp 22 may be a home automated lamp or just coupled to the home system via the internet (i.e., internet of things (IoT)). The user 20′ is holding his/her device 2 in his hands in front of the body so that the eye tracker (not indicated in FIG. 4) can track the user's 20′ eyes 24. This is indicated by dashed lines B. The device 2 and the eye tracker, respectively, will discover that the user's gaze is currently focusing on the lamp 22. Since the user 20′ is moving in a known environment, namely his home, office or any other familiar space, the device 2 will discover that the user's gaze direction is focused on the lamp 22 and identify the lamp 22 as the real world object. This may for instance be done by the processing unit by correlating the eye tracking data with data from the camera 14.

Once the real world object, the lamp 22, is identified the device 2 may provide the option to adjust the dimming or switch (at least one parameter) the light on/off. The user 20 may then give an input via voice control, the display, which may be a touch display, or via a button on the device 2 and adjust the parameter and thus dimming or switching the light off or on.

The device 2 may be trained to recognize familiar spaces the user 20′ is usually moving in. The home of the user 20′ or the office of the previously stated can be any type of camera, so that the device 2 and the processing unit 18, respectively, know where the user is and what devices objects are positioned where. Once can imagine that this works for loudspeakers, smart TV's, smart locks, etc.

The above 3 examples, example 1, example 2 and example 3 illustrate the invention by using objects such as the smaller one of the two mountains (FIGS. 2 and 3) or the lamp (FIG. 4). It is however clear and falls within the scope of the invention that the object may be a subject, such as an animal or a person, and the device 2 may then provide information on the person or animal.

The method or system according to the invention may comprise a time trigger so that when the user's gaze is fixating a real world object item or subject for a certain time period, the device will know that a picture should be taken, the lamp should be switched on or off/dimmed, etc. The time period may be from several milliseconds up to 5 seconds. As an example, when the user is fixating the lamp 22 with his/her gaze for like 1, 2, 3 or 4 seconds the processing unit 18 of the device 2 may know that the lamp 22 is now of interest for the user 20′ and that therefore at least one parameter relating to the lamp 22 should be somehow adjusted.

The term “holding the device 2 in front of the user's body” describes that the device 2 and in particular the eye tracker of the device 2, when the eye tracker is integrated in the device 2, can always “see” the eyes of the user. So as long as the device 2 is held somewhere in front of a plane defined by the user's longitudinal axis and an axis extending through the two eyes of the user 20/20′ the eye tracker can “see” the eyes and track the user's gaze. Thus the eye tracker should have a free line of sight to at least one of the user's eyes.

The eye tracker 4 may also use the camera 14 (c.f. FIG. 1) when tracking the eyes of the user 20, 20′ or any other available camera.

FIG. 5 illustrates a method according to the present invention. The method is for assisting a user using the system comprising the eye tracker and the device, the device being configured to be worn on a limb of the user or held in the hands of the user, the method comprising the steps of (1) tracking (S01) the user's gaze direction in the real world environment and determining (S02) a real world object, subject or item the user is currently focusing on based on the user's gaze direction; and (2) providing (S04) information and/or an option to adjust at least one parameter, for example via the device, based on the identified real world object, subject or item.

As explained previously the at least one parameter can be an operating parameter of a home automated appliance (FIG. 4) or an internet of thing appliance and wherein the identified real world object is such a home automated appliance or an internet of thing appliance.

The method may further comprise the steps of (1) inputting (S03) input information into the device; and (2) providing information or the option to adjust the at least one parameter depending on the input information.

The step of inputting input information into the device may be optional. In some applications the input of information may be the tracking of the user's gaze in particular the identified real world object, subject or item.

The invention has now been described by referring to the enclosed figures but is in no way limited to such applications. As indicated in the introduction, another application may be to translate signs in the real world that the user's gaze is fixate on or providing information about a sightseeing place or object when the user is exploring an area as a tourist.

Another application is for instance to identify individuals and people and directly looking them up via LinkedIn™, Facebook™ or other social media platforms and giving name and title and provide the information via a headset, earphones or a screen.

All the above steps and examples can be done/performed without the user looking at the device 2. In particular if the user is wearing headphones, the information can be given by an audio signal and the input information can be given to the device via voice control, without the user manipulating a touch screen or the screen of the device.

What is claimed:

1. A method for assisting a user using a system comprising an eye tracker and a device, the device being configured to be worn on a limb of the user or held in the hands of the user, the method comprising the steps of:
tracking, with the eye tracker, the user's gaze direction in a real world environment;
providing information and/or an option to adjust at least one parameter of an apparatus, via the device, based on the user's gaze direction.

2. The method according to claim 1, wherein the method further comprises the steps of:
determining a real world object, subject, or item the user is currently focusing on based on the user's gaze direction; and
wherein providing information and/or an option to adjust the at least one parameter of the apparatus, via the device, is further based on the real world object, subject, or item.

3. The method according to claim 1, wherein the at least one parameter is an operating parameter of a home automated appliance or an internet of things appliance and wherein the identified real world object is the home automated appliance or the internet of things appliance.

4. The method according to claim 1, wherein the method further comprises the steps of:
inputting input information into the device; and
wherein providing information and/or an option to adjust the at least one parameter of the apparatus, via the device, is further based on the input information.

5. The method according to claim 4, wherein the input information is a picture taken with a camera of the device and wherein the at least one parameter is the focus of the camera of the device based on the user's gaze direction or the identified object, subject or item.

6. The method according to claim 4, wherein the input information is a picture taken with a camera and wherein the at least one parameter is a corresponding manipulation parameter of the camera based on the identified object, subject, or item and the input information.

7. The method according to claim 6, wherein the manipulation parameter is a cropping variable.

8. The method according to claim 6, wherein the manipulation variable is a zooming variable.

9. The method according to claim 4, wherein the input information is an instruction to translate text on the real world object, subject, or item, and wherein the information is audio information comprising an audio translation of the text or visual information showing the translated text.

10. The method according to claim 1, wherein the user is not looking at the device during the method being performed.

11. A system comprising
a device comprising a processing unit, a memory, and a camera;
an eye tracker, wherein the eye tracker is configured to determine a user's gaze direction in a real world environment; and
wherein the device is configured to be worn on a limb of the user or held in the hands of the user, wherein the eye tracker is configured to track the user's gaze direction in the real world environment, and wherein the processing unit is configured to provide information and/or an option to adjust at least one parameter of an apparatus, via the device, based on the user's gaze direction.

12. The system according to claim 11, wherein the processing unit is configured to determine a real world object, subject, or item the user is currently focusing on based on the user's gaze direction; and to provide information and/or an option to adjust at least one parameter, preferably via the device, based on the identified real world object, subject or item.

13. The system according to claim 11, wherein the device is a watch.

14. The system according to claim 11, wherein the device is a phone, a smart phone, a handheld gaming device, or a tablet.

15. The system according to claim 11, wherein the eye tracker comprises a light source and a camera.

16. The system according claim 11, wherein the device comprises the eye tracker.

17. The system according to claim 16, wherein the eye tracker tracks the user's gaze direction via the device and wherein the processing unit correlates the user's gaze direction with the real world environment.

18. The system according to claim 11, wherein the device further comprises an interface for inputting input information into the device and for communication with the user.

19. The system according to claim 18, wherein the processing unit is configured to receive input information via the interface, and wherein the input information is an instruction to take a picture and wherein the at least one parameter is to focus the camera or another camera on the object, subject, or item.

20. The system according to claim 11, wherein the apparatus comprises the device.
